(19) United States
(12) Patent Application Publication
(10) Pub. No.: US 2009/0287645 A1
(43) Pub. Date: Nov. 19, 2009

(54) SEARCH RESULTS WITH MOST CLICKED NEXT OBJECTS

(75) Inventors: Ali Dasdan, San Jose, CA (US); Santanu Kolay, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/120,993

(22) Filed: May 15, 2008

(51) Int. Cl. G06F 7/06

(52) U.S. Cl. 707/3; 707/E17.014

(57) ABSTRACT

Disclosed are apparatus and methods for providing next click information regarding search results. In certain embodiments, as objects (such as web pages, images, videos, audio files) are searched and clicked, click information is retained. Next click information with respect to specific objects can then be determined. This next click information can then be provided to an object search initiator so that such next click information is presented along with search result objects, for example, during a search query.

### BACKGROUND OF THE INVENTION

The field of the invention includes search services provided over a computer network. The field especially pertains to providing search results and associated information in response to a search term query or within another type of object browsing or search application.

In recent years, the Internet has been a main source of information for millions of users. These users rely on the Internet to search for information of interest to them. One conventional way for users to search for information is to initiate a search query through a search service's web page. Typically, a user can enter one or more search term(s) into an input box on the search web page and then initiate a search based on such entered search term(s). In response to a query, a web search engine generally returns an ordered list of search result documents.

FIG. 1 is a screen shot showing a portion of a search web page 100 in which a search query has been initiated for the search term “orange” 102 and a list of search results 104 have been presented based on such search term “orange” 102. As shown, each entry in the list of search results 104 typically includes a title (e.g., title 106a and 106b), a universal resource locator (URL) link (e.g., 110a and 110b), and an abstract (e.g., 108a and 108b). The abstract gives a concise summary to the user that indicates something about why the associated search result document is relevant for the particular query, and the title may provide an even briefer description of the search result document. Although the title and abstract together provide information regarding a particular search result link, it would be beneficial to provide improved mechanisms for presenting search results.

### SUMMARY OF THE INVENTION

Accordingly, apparatus and methods for providing next click information regarding search results are provided. In certain embodiments, as objects (such as web pages, images, videos, audio files) are searched and clicked, click information is retained. Next click information with respect to specific objects can then be determined. This next click information can then be provided to an object search initiator so that such next click information is presented along with search result objects, for example, during a search query.

In one embodiment, a method for providing search results to a user of a search service is disclosed. Next click information is obtained, and this next click information pertains to next clicked objects that are related to each of at least a subset of search result objects, which were obtained over a computer network by a search service in response to a search request by an initiator. Each of the next clicked objects was selected by a user next after accessing the related search result object. The next click information is provided, along with the ranked search result objects, to the initiator so that the next click information is presented adjacent to each related one of the at least a subset of ranked search result objects.

In a specific implementation, the next clicked objects and the search result objects are web pages. In another embodiment, the provided next click information is partitioned into inter-object and intra-object information with respect to the at least a subset of search result objects. In another aspect, the provided next click information is partitioned into inter-domain and intra-domain information with respect to the at least a subset of search result objects. In yet another aspect, the provided next click information was obtained from a single user that is the same as the initiator of the search request. In another feature, the provided next click information was obtained from a plurality of users that belong to a social network of the initiator of the search request. In another embodiment, the provided next click information includes a plurality of click frequency values. In a further aspect, the click frequency values are presented as a visual map. In yet another embodiment, the provided next click information are presented for each of the at least a subset of ranked search result objects in an order corresponding to increasing to decreasing number of clicks. In another feature, the next clicked objects are advertisement links. In yet another embodiment, the next click information includes other data that can be collected together with the clicks. One such data is the time spent on the page that contains the object of interest. In a further aspect, the search result and the next click information can come from different sources, for example, databases, owned and operated by the same company or different companies.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a screen shot showing a portion of a search web page in which a search query has been initiated and a list of search results have been presented based on such search query.

FIG. 2 illustrates an example network segment in which the present invention may be implemented in accordance with one embodiment of the present invention.

FIG. 3A illustrates an example user search database in accordance with one implementation of the present invention.

FIG. 3B illustrates an example user web database for tracking user object access in accordance with one embodiment of the present invention.

FIG. 4 is a flow chart illustrating a next click management procedure in accordance with one embodiment of the present invention.

FIG. 5 is a flow chart illustrating a procedure for next clicks collection in accordance with a specific implementation of the present invention.

FIG. 6A illustrates two example next clicks databases in accordance with specific embodiments of the present invention.

FIG. 6B is a screen shot illustrating the presentation of a plurality of search results and next click information in accordance with a specific implementation of the present invention.

FIG. 7 illustrates an example computer system in which specific embodiments of the present invention may be implemented.

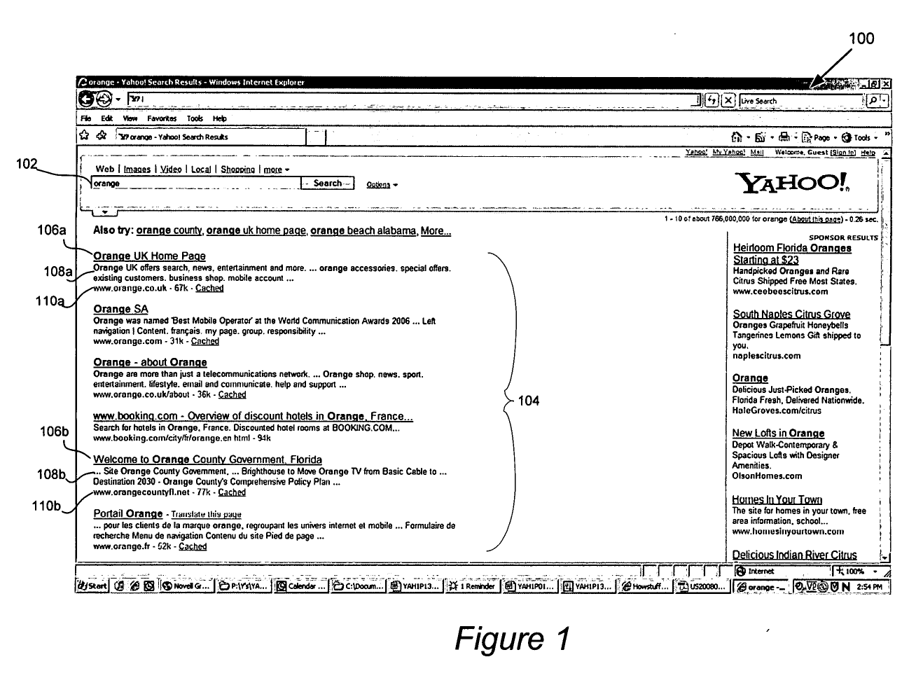

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, mechanisms for providing next click information for search result objects are provided. The search result objects may take any suitable form, such as web pages, images, videos, audio files, or any object that can be selected, viewed, or otherwise accessed. A next click object for a particular search result object may correspond to any type of object (e.g., web page, image, video, audio files, advertisement link, etc.) that is selected, clicked, viewed or accessed by a user after selecting, clicking, viewing, or otherwise accessing the particular search result object. A search result object can also be a software plug-in from a plug-in library. In this case, the next click object can show the most used or accessed plug-in associated with the particular search result. The search result object may have been initially accessed through any suitable application, such as a search or web service. As a user accesses particular search result objects and subsequent next click objects, next click information may be retained for later use. In one embodiment, when a user performs a search query, next click information for each search result object (or a subset of search result objects) is provided to the user along with the presented search results as described further below.

Example embodiments of the present invention may be utilized to significantly enhance the search interface and search experience. The next click information can help a user navigate through a high number of search results and find related pages.

Although certain embodiments are described herein in relation to search result objects and their related next click objects in the context of a search service application, it should be apparent that next click information may also be provided in other applications, such as a music or video service for browsing/searching through audio visual objects. It should also be noted that embodiments of the invention are contemplated in which the operation of the underlying search engine is largely unaffected by the overlying determination and presentation of next click information. That is, in response to a search query, the search engine may acquire information relating to the search query as it would conventionally, i.e., without the benefits of or reference to the user click information enabled by the present invention. The user click information may be applied to the conventionally retrieved results. However, embodiments are also contemplated in which the operation of the underlying search engine is altered in some way to enable at least some further search enhancements as described further below. For example, the ranking of the search results may be affected by the user click information that is retrieved and the search engine may be revised based on the retrieved user click information as explained further below.

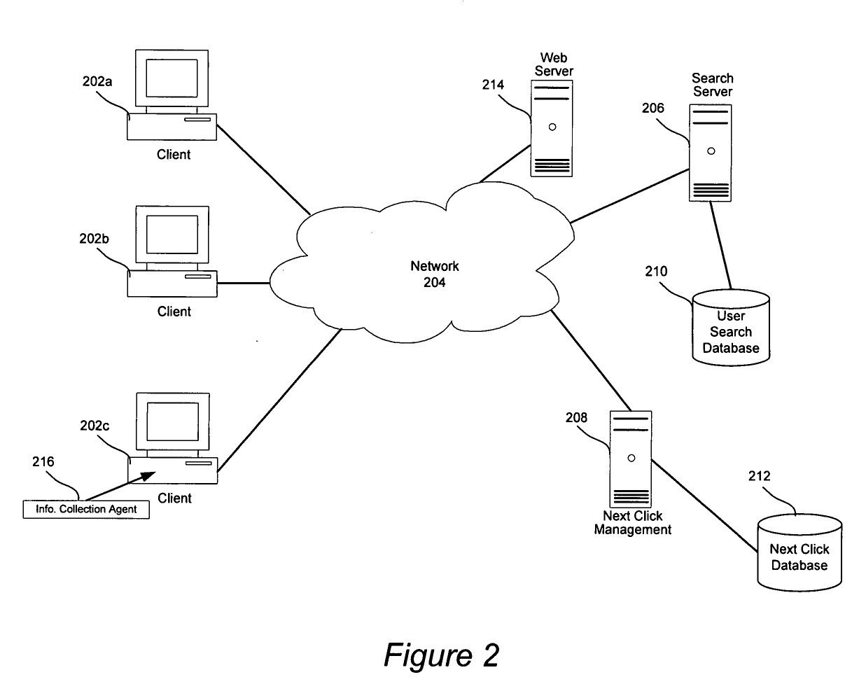

Prior to describing mechanisms for providing next click information, a search and web architecture will first be briefly described to provide an example context for practicing techniques of the present invention. FIG. 2 illustrates an example network segment in which the present invention may be implemented in accordance with one embodiment of the present invention. As shown, a plurality of clients 202 may access a search application, for example, on search server 206 via network 204 and/or access a web service, for example, on web server 214. The network may take any suitable form, such as a wide area network or Internet and/or one or more local area networks (LAN's). The network 204 may include any suitable number and type of devices, e.g., routers and switches, for forwarding search or web object requests from each client to the search or web application and search or web results back to the requesting clients.

The invention may also be practiced in a wide variety of network environments (represented by network 204) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via network 204 and related to one or more search terms. The search terms may be entered by a user in any manner. For example, the search application may present a web page having any input feature to the client (e.g., on the client's device) so the client can enter one or more search term(s). In a specific implementation, the search application presents an input box into which a user may type any number of search terms. Embodiments of the present invention may be employed with respect to any search application, and example search applications include Yahoo! Search, Google, Altavista, Ask Jeeves, etc. The search application may be implemented on any number of servers although only a single search server 206 is illustrated for clarity.

The search server 206 (or servers) may have access to one or more user search database(s) 210 into which search information is retained. Each time a user performs a search on one or more search terms, information regarding such search may be retained in the user search database(s) 210. For instance, the user's search request may contain any number of parameters, such as user or browser identity and the search terms, which may be retained in the user search database(s) 210. Additional information related to the search, such as a timestamp, may also be retained along with the search request parameters. When results are presented to the user based on the entered search terms, parameters from such search results may also be retained. For example, the specific search results, such as the web sites, the order in which the search results are presented, whether each search result is a sponsored or algorithmic search result, the owner of each search result, whether each search result is selected by the user (if any), and a timestamp may also be retained in the user search database(s) 210.

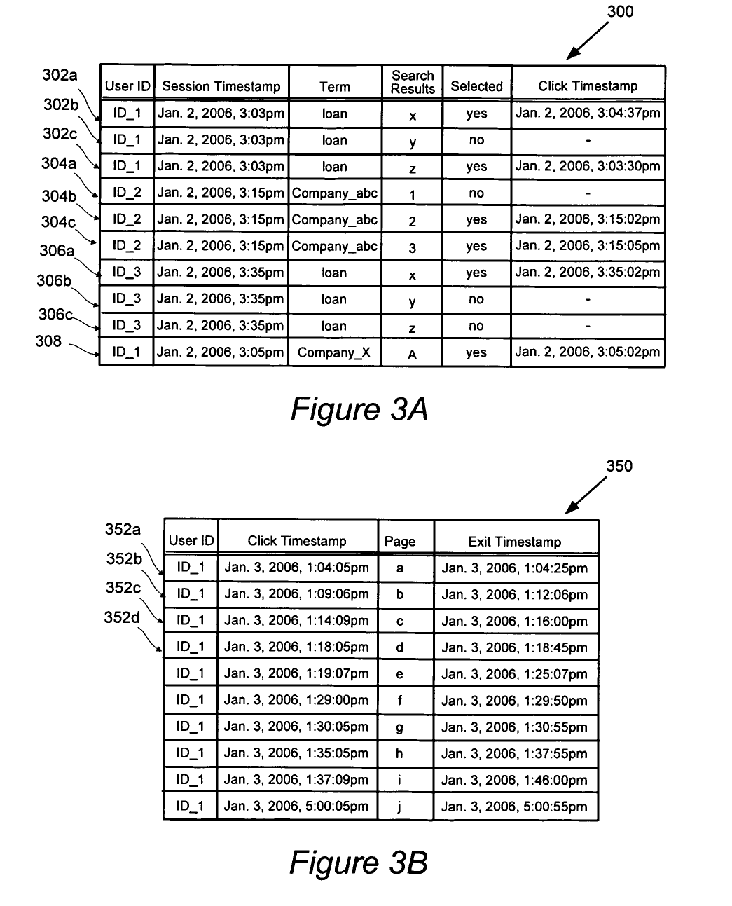

The user search database(s) may take any suitable form for retaining useful search information for subsequent or concurrent next click analysis, which is described below. FIG. 3A illustrates an example user search database 300 in accordance with one implementation of the present invention. As shown, the user search database 300 includes a plurality of entries 302a˜302c for a first search by a first user ID_1, entries 304a˜304c for a second search by a second user ID_2, entries 306a˜306c for a third search by a third user ID_3; and entry 308 for a fourth search by the same user ID_1. Of course, each search would more typically include a higher number of entries than shown in FIG. 3A. An abbreviated list of search results is illustrated for each search in FIG. 3A for simplification purposes. Additionally, the illustrated database 300 is merely an example, and such a database may include any number and type of fields for tracking individual searches and search results from a plurality of search sessions.

Each entry relates various parameters of a particular user's search session for a particular search term and various characteristics of a search result that is found in response to such search and search term. In the illustrated example, each entry may include a user identifier (ID), session timestamp, search term, a search result identification, whether such search result was clicked by the user, and the timestamp for such click. Although not shown, each entry may also include a field indicating whether such search result is a sponsored search result (e.g., that is purchased for the particular search term) and/or an identification of the owner of the search result. Alternatively, each entry may include a user ID and a plurality of searches that each includes a timestamp, one or more search term(s) and their corresponding search results and related information. There is a diverse number of different arrangements that could be utilized for such search information. The retained search information may include other types of data, such as the rank of the selected result among all of the search results, a category for the search term, etc.

The user ID may correspond to any characteristic associated with the searcher, and the searcher may be a person or an automated entity. This ID may be associated directly with some form of a user's identity, associated with the browser through which the user is requesting a search, or a search client that is running on the user's device. By way of example, the user ID may be obtained from a browser or user cookie, e.g., which may be associated with the search when the user is logged into the particular search service provider. Alternatively, the user ID may take the form of an identity associated with the device which the user is using for their search. Examples of a device identity include IP (internet protocol) addresses or MAC (media access control) addresses.

The session and click timestamp fields may correspond to any suitable time format, and may specify any combination of day, month, year, time, and time zone. The search term corresponds to a search term that was used in a specific search. A specific search may include more than one search term, which may be included in the same or a different entry of the user search database. A search result may include one or more URL (universal remote locator) sites that belong to a same owner. A “no” in the selected field indicates that the search results were not selected by the user, while a “yes” in the selected field indicates that the search result was selected by the user.

A sponsored field may be included in the entry to specify whether the search result has been sponsored (e.g. a bid accepted) so as to appear in a purchased or sponsored search results list. An owner field may specify an owner of the search result. An owner is generally an entity that controls or manages the corresponding search result. For instance, the owner can be a company and the search result can specify the company's main website.

In the present example, a separate entry may be formed for each search term and search result pair. For example, entries 302a˜302c each include a user ID equal to “ID_1” and a session timestamp “Jan. 2, 2006, 3:03 pm” for a first search. Entries 302a˜302c also correspond to a search for the search term “loan”, which produces search result x, y, and z.

In addition to a user search database, embodiments of the present invention may utilize information that is collected when users access one or more web services. In a specific implementation, one or more clients may be configured with an information collection agent, e.g., 216 of FIG. 2. The information collection agent may be configured to intercept requests from the client for any object, such as a web page to a particular service provider, before forwarding such request to its service provider. For instance, the client browser may include a plug-in that receives URL (universal resource locator) requests made by the user for particular web pages. The information collection then receives the object, e.g., web page, from the service provider in response to the object request. The information collection agent may also be configured to retain data regarding the search request and resulting object, such as an identification of the user, the result object (e.g., URL) and timestamps for accessing and exiting such result object. This information may then be forwarded to a central server, such as next click management server 208 and retained in a central database, such as next click database 212.

FIG. 3B illustrates an example user web database 350 for tracking user object access in accordance with one embodiment of the present invention. As shown, the user web database 350 may include a plurality of entries (e.g., 352a-d) that each may include a user identification, a click timestamp, a page identifier, and an exit timestamp. Although not shown, a user web database may include entries for a plurality of users and web pages, as well as other fields related to such users and web pages. The click timestamp may indicate when the user initially receives the particular object or web page and the exit timestamp may indicate when the user exits such object or web page. Thus, the user's time spent accessing each object may be retained and later utilized for next click analysis purposes.

Referring back to the architecture of FIG. 2, next click management module 208 may be configured to determine next click information for a plurality of search result objects, accessed web objects, or the like. The next click information may be determined based on any suitable information regarding objects that are accessed next with respect to accessing a particular object. For instance, the next click management module 208 may analyze information retained for a plurality of users as they search and access search result objects and request and access objects, such as web pages. Although the next click management module 208 is shown as a separate server, the next click management module 208 and/or the next click database(s) 212 may be merged with user search server 206 and database(s) 210 and/or information collection agent 216 and/or web database 350.

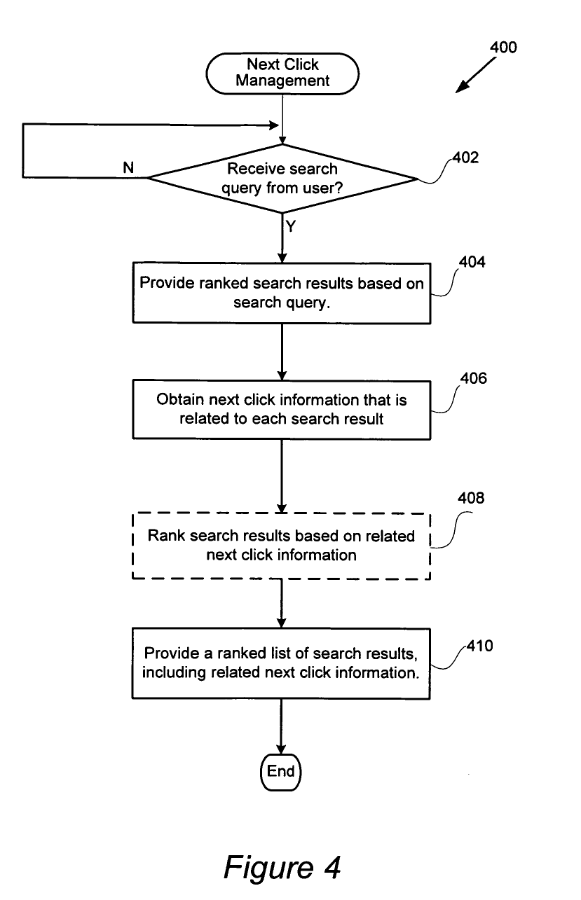

FIG. 4 is a flow chart illustrating a next click management procedure 400 in accordance with one embodiment of the present invention. In this example, next click information is applied in a search context. Accordingly, it may initially be determined whether a search query has been received from a user in operation 402. If a search query has not been received, the procedure 400 continues to wait. When a search query is received, ranked search results may then be provided based on the search query in operation 404. For instance, the next click management module may be integrated with a search service application or a search application may inform a next click server of each search request and the resulting search results.

When a search for objects based on one or more search terms is initiated in a query to a search server, the search server then locates a plurality of objects that relate to the search terms. These objects can be found on any number of web servers and usually enter the search server via a crawling and indexing pipeline possibly performed by a different set of computers (not shown). The plurality of located objects may then be analyzed by a rule based or decision tree system to determine a “goodness” or relevance ranking. For instance, the objects are ranked in order from most relevant to least relevant based on a plurality of feature values of the objects, the user who initiated the search with a search request, etc.

Referring back to FIG. 4, next click information that is related to each search result may then be obtained in operation 406. Alternatively, next click information may have been previously determined as user search or web access data was collected. Next click information may generally correspond to next clicks that were previously made by the current search initiator, the user's social network, or a plurality of public users. The next click information may include metrics for frequency of clicks for each next clicked object as described further below.

The search results may also be optionally ranked again based on the related next click information in operation 408. That is, the next click information may be taken into account by a re-ranking algorithm. For example, objects (e.g., pages) that have a high frequency next click rank may be re-evaluated and given a higher ranking than lower frequency next click objects or particular search results may be clustered together based on next click information. A ranked list of search results, including the related next click information, may then be provided to the initiator of the search (e.g., a device accessible by such user) in operation 410. For example, the next click information is provided adjacent to the corresponding search result as described further below.

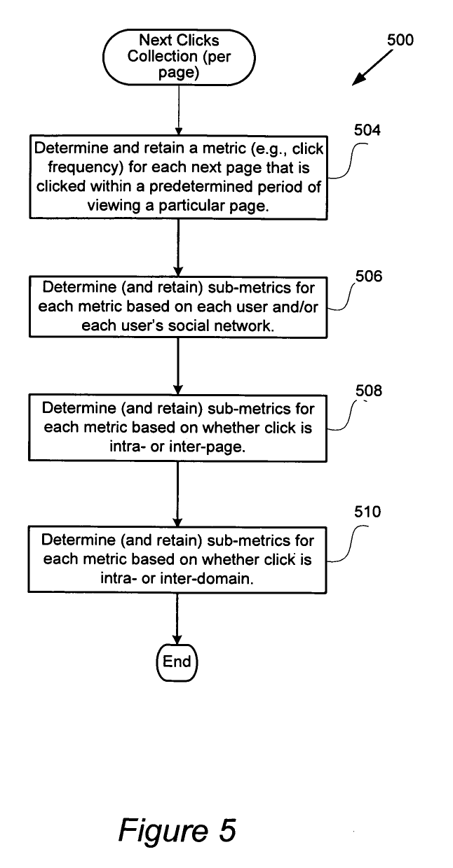

FIG. 5 is a flow chart illustrating a procedure 500 for next clicks collection in accordance with a specific implementation of the present invention. This flow is presented with respect to a single page object, but in reality may be applied to a plurality of web pages, including search pages that are accessed through a search service and web pages that are accessed through a web server. Of course, next click information may be collected and provided for other types of objects, besides web pages. For examples, the next click information may correspond to images, videos, audio files, advertisement links, software plug-ins, etc.

Additionally, next click information, including metrics, may be collected and determined during any suitable time. For instance, next click metrics may be determined and updated based on user search and user web database information each time a search is performed or on a periodic basis. Alternatively, next click metrics may be determined as search and web information is provided, e.g., to next click management server. Search and web information may be provided by one or more search servers, one or more information collection agents, one or more web servers, etc. A next click management server may obtain such search and web information by passively receiving such information or actively requesting such information from the respected information sources.

Referring back to FIG. 5, a metric for each next page that is clicked within a predetermined period of viewing a particular page may be determined and optionally retained (e.g., in next click database 212) in operation 504. Long term storage of next click metrics is optional. For example, if metrics are determined and provided for each search whenever such search occurs, the next click metrics need only be temporarily stored for presentation to the search initiator.

A next click metric may take any suitable form for presenting next click characteristics, such as click frequency, click count, time spent on viewing the object (dwell time), tag count, intra-page click count, etc. A metric may include any quantification or characterization of how a user is viewing an object, such as a web page. These specified metrics are merely examples and are not meant to limit the scope of the invention. A next click frequency may specify a percentage that the next click object is selected from a total of next click objects for a particular search result object. For instance, if there are 1,000 next click objects that were selected by different users after accessing a particular search result object and a particular one of these next click objects was selected 500 times, the click frequency for the particular next click object is 50%.

The next click metrics may also each be partitioned into any number and type of categories. For example, sub-metrics for each metric may be determined and optionally retained based on each user and/or each user's social network in operation 506. In a specific implementation, a particular user may choose to have next click information presented based on his/her own next clicks, next clicks made by the particular user's selected social network, e.g., designated friends or buddies, or anyone's clicks. A user may choose these options at any time, e.g., for applying to a particular search or by selecting more generally applicable user preferences through a user profile web page.

Sub-metrics for each metric may also be determined and retained based on whether clicks are intra- or inter-page in operation 508. That is, next click objects that were selected from links within the particular related search result object can be defined as intra-page or intra-object, while next click objects that were not selected from links within the related search result object can be defined as inter-object or inter-page. Sub-metrics for each metric may also be determined and retained based on whether clicks are intra or inter-domain in operation 510. For example, next clicks that were selected from objects within a same domain as the related search result object may be defined as intra-domain, while other next clicks may be defined as inter-domain. Other sub-metrics may be determined based on any suitable next click factors, such as the degree of overlap of content, e.g., words or search terms, within the next click objects themselves, anchor text similarity, user tag similarity, overlapping of predefined categories of such next click objects (e.g., automotive, finance), whether the next click objects belong to a same advertising category, etc.

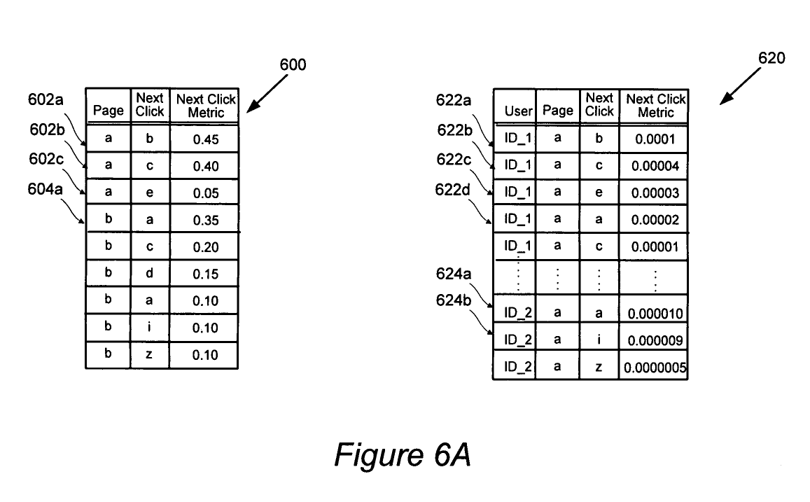

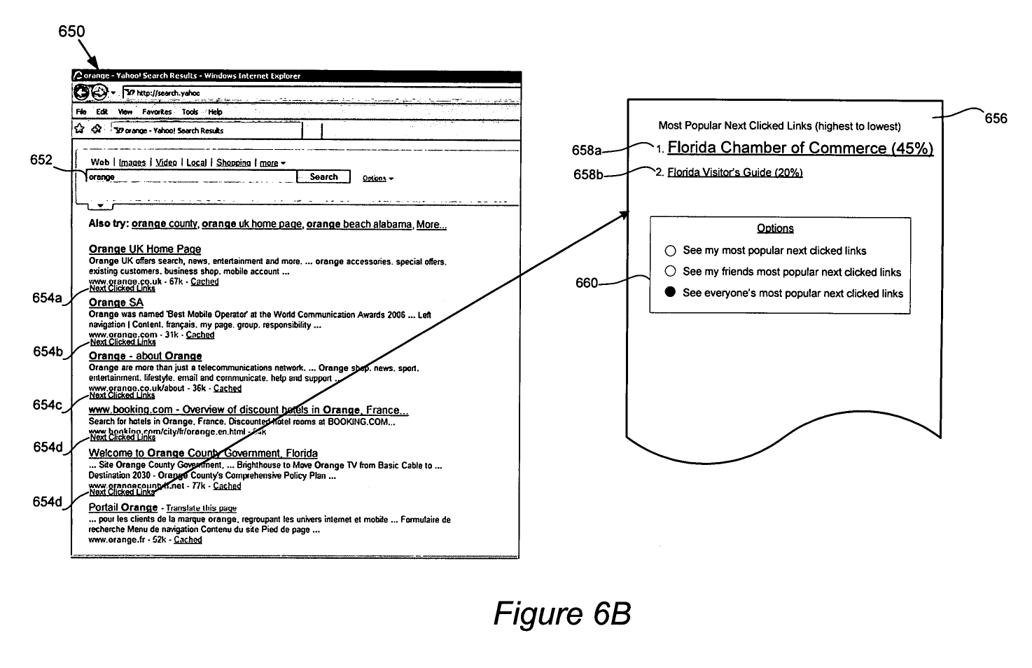

FIG. 6A illustrates two example next clicks databases 600 and 650 in accordance with specific embodiments of the present invention. These examples relate to web pages, but could also be applicable to other types of objects. Next clicks database 600 includes a plurality of entries that each relates a web page to a next click page and next click metric. For example, entries 602a-c relate web page “a” with next click web pages b, c, and e, respectively. These next click web pages b, c, and e have click frequencies of 45%, 40%, and 5%, respectively. Entry 604a relates another web page “b” to next click page “a” with a 35% click frequency.

Alternative next click database 650 includes a plurality of entries that each includes a user identifier (ID), a web page, a next click web page, and a next click metric. The user ID may correspond to a single user identity or a particular user's set of social network users. In this embodiment, the next click metrics are effectively partitioned by user or social network. Intra- or inter-domain may also be inherently provided by the particular web page's and next click page's identities. For instance, a particular web page and next click page may share a same domain. Intra- or inter-page status may be determined by analyzing the particular web page to determine whether such particular web page includes a link to the next click web page.

Each time a plurality of search results are provided to a search initiator, the next click information that corresponds to each (or a subset) of the search results may also be provided to the user. For instance, the next click metric for each next click web page that is related to each particular search result's web page may be obtained from a next clicks database, e.g., 600 or 650. Inter- and intra page and/or domain sub-metrics may also be determined for each metric. For instance, the next clicks metrics are first divided into sub-metric categories by comparing the web page's and next click page's identified domains to determine inter or intra-domain status or by assessing whether each next click page is provided as a link in the related web page to determine inter- or intra-page status. Sub-metrics may then be determined based on the next click count of each category and the corresponding metric values.

After next click metrics and sub-metrics are obtained, next click information for one or more search results may then be provided to the search initiator. FIG. 6B is a screen shot illustrating the presentation of a plurality of search results and next click information in accordance with a specific implementation of the present invention. As shown, search results window 650 includes a plurality of search results that each includes a selectable “Next Clicked Links” object, e.g., 654a-d. In another implementation, a predefined number of next clicked links (e.g., the top 10) can also be presented as links or search results along with the search query's search results. In this case, an indentation can be used to separate the next click links from the regular search query's results. When a user selects one of these “Next Clicked Links” objects for a particular search result, corresponding next click information may then be presented to the user. As shown, next clicks information document 656 is presented when the “Next Clicked Links” object 654d is selected.

The next clicks information for a set of search results may be provided in numerous formats. In the illustrated example, a dynamic “Next Clicked Links” object is first presented to the user. However, the next clicks information may be statically provided to the user. In the present example, when the user selects the dynamic “Next Clicked Links” object, the user is presented with additional next click information in a web page or window. In an alternative implementation, the search results may be presented with a different type of designation, e.g., “Next Clicks Information”, over which the user may pass his/her mouse or pointer to cause a popup window to be presented with next clicks information.

Referring to the selectable link example of FIG. 6B, the next click information document 656 may include a list of next click objects for the selected search result, e.g., 658a and 658b, which are presented in an order of highest to lowest popularity. The next click objects for a particular search result may be presented in any order, and such order may be selectable by the user or by some other entity. In the illustrated example, the next click objects are presented in an ordered list corresponding to descending levels of click frequency. Alternatively or additionally, next click objects may be visually presented in a way to indicate their relative click frequencies or any other metric values. For example, the highest click frequency object may be presented in a largest font (as illustrated), while the next highest click frequency object is presented in a next largest font, etc. In this latter example, the next click objects do not have to be presented in a list, but can be arranged randomly on the next clicks page as a visual map, e.g., as a tag or data cloud. The next click objects may also be presented in other visual ways that correspond to a scale of a particular metric or sub-metric. Visual representations that may correspond to a metric scale may include different colors, different fonts, differently sized shapes, etc.

The metric values (and/or sub-metric values) may also be provided in the presented next click information. As shown, each next click object includes a corresponding next click frequency in parenthesis, 45% for the first next click object 658a and 20% for the second next click object 658b. Alternatively, the next click information may simply present the different next click values in the form of numbers or any other visual scale. Regardless of form, any next click information portion may be in the form of a selectable link to the corresponding next click object, e.g., next click web page.

Mechanisms for allowing the user to select next click options may also be provided. In the example of FIG. 6B, the user is presented with selectable options 660, which allow the user to select the type of presented next click information, e.g., the most popular next click objects that were selected by the user, the user's social network, or by the public. Other selectable next click options may include presenting the next click information based on intra- or inter-page, intra- or inter-domain, the number of presented next click objects, etc. Selectable next click options may be accessed and chosen by a user before the search, e.g., the options are presented adjacent to the search input box or accessed within a user preference option for a particular service provider account.

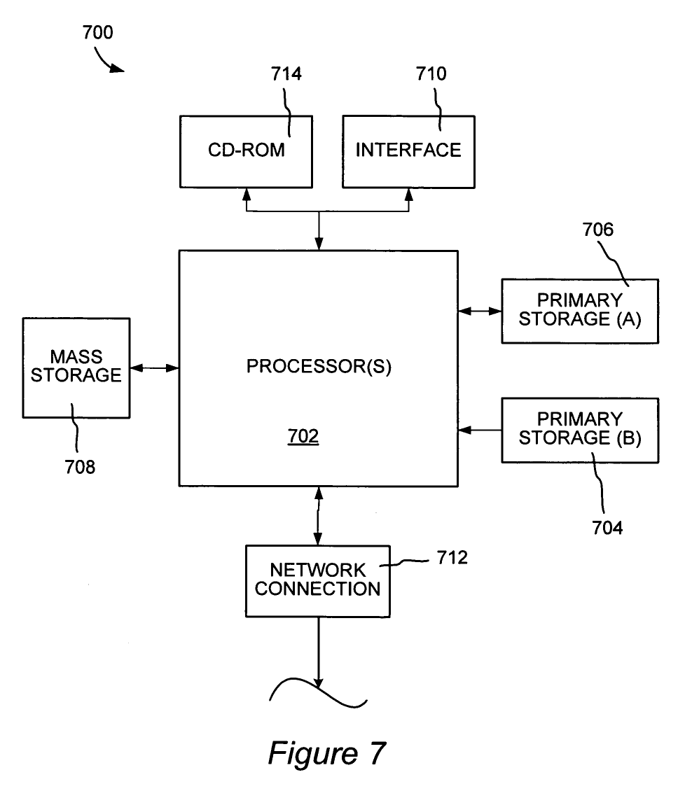

The present invention may be implemented in any suitable combination of hardware and/or software. FIG. 7 illustrates a typical computer system that, when appropriately configured or designed, can serve as a next click manager of this invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store user search database(s), user web information database(s), next click database(s), etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for providing search results to a user of a search service, comprising:
obtaining next click information regarding next clicked objects that are related to each of at least a subset of search result objects, which were obtained over a computer network by a search service in response to a search request by an initiator, wherein each of the next clicked objects was selected by a user next after accessing the related search result object; and
providing the next click information, along with the ranked search result objects, to the initiator so that the next click information is presented adjacent to each related one of the at least a subset of ranked search result objects.

2. A method as recited in claim 1, wherein the next clicked objects and the search result objects are web pages.

3. A method as recited in claim 1, wherein the provided next click information is partitioned into inter-object and intra-object information with respect to the at least a subset of search result objects.

4. A method as recited in claim 1, wherein the provided next click information is partitioned into inter-domain and intra-domain information with respect to the at least a subset of search result objects.

5. A method as recited in claim 1, wherein the provided next click information was obtained from a single user that is the same as the initiator of the search request.

6. A method as recited in claim 1, wherein the provided next click information was obtained from a plurality of users that belong to a social network of the initiator of the search request.

7. A method as recited in claim 1, wherein the provided next click information includes a plurality of click frequency values.

8. A method as recited in claim 6, wherein the click frequency values are presented as a visual map.

9. A method as recited in claim 1, wherein the provided next click information are presented for each of the at least a subset of ranked search result objects in an order corresponding to increasing to decreasing number of clicks.

10. A method as recited in claim 1, wherein the next clicked objects are advertisement links.

11. An apparatus comprising at least a processor and a memory, wherein the processor and/or memory are configured to perform the following operations:
obtaining next click information regarding next clicked objects that are related to each of at least a subset of search result objects, which were obtained over a computer network by a search service in response to a search request by an initiator, wherein each of the next clicked objects was selected by a user next after accessing the related search result object; and
providing the next click information, along with the ranked search result objects, to the initiator so that the next click information is presented adjacent to each related one of the at least a subset of ranked search result objects.

12. An apparatus as recited in claim 11, wherein the next clicked objects and the search result objects are web pages.

13. An apparatus as recited in claim 11, wherein the provided next click information is partitioned into inter-object and intra-object information with respect to the at least a subset of search result objects.

14. An apparatus as recited in claim 11, wherein the provided next click information is partitioned into inter-domain and intra-domain information with respect to the at least a subset of search result objects.

15. An apparatus as recited in claim 11, wherein the provided next click information was obtained from a single user that is the same as the initiator of the search request.

16. An apparatus as recited in claim 11, wherein the provided next click information was obtained from a plurality of users that belong to a social network of the initiator of the search request.

17. An apparatus as recited in claim 11, wherein the provided next click information includes a plurality of click frequency values.

18. An apparatus as recited in claim 16, wherein the click frequency values are presented as a visual map.

19. An apparatus as recited in claim 11, wherein the provided next click information are presented for each the at least a subset of ranked search result objects in an order corresponding to increasing to decreasing number of clicks.

20. An apparatus as recited in claim 11, wherein the next clicked objects are advertisement links.

21. At least one computer readable storage medium having computer program instructions stored thereon that are arranged to perform the following operations:
obtaining next click information regarding next clicked objects that are related to each of at least a subset of search result objects, which were obtained over a computer network by a search service in response to a search request by an initiator, wherein each of the next clicked objects was selected by a user next after accessing the related search result object; and
providing the next click information, along with the ranked search result objects, to the initiator so that the next click information is presented adjacent to each related one of the at least a subset of ranked search result objects.

22. At least one computer readable storage medium as recited in claim 21, wherein the next clicked objects and the search result objects are web pages.

23. At least one computer readable storage medium as recited in claim 21, wherein the provided next click information is partitioned into inter-object and intra-object information with respect to the at least a subset of search result objects.

24. At least one computer readable storage medium as recited in claim 21, wherein the provided next click information is partitioned into inter-domain and intra-domain information with respect to the at least a subset of search result objects.

25. At least one computer readable storage medium as recited in claim 21, wherein the provided next click information was obtained from a single user that is the same as the initiator of the search request.

26. At least one computer readable storage medium as recited in claim 21, wherein the provided next click information was obtained from a plurality of users that belong to a social network of the initiator of the search request.

27. At least one computer readable storage medium as recited in claim 21, wherein the provided next click information includes a plurality of click frequency values.

28. At least one computer readable storage medium as recited in claim 26, wherein the click frequency values are presented as a visual map.

29. At least one computer readable storage medium as recited in claim 21, wherein the provided next click information are presented for each the at least a subset of ranked search result objects in an order corresponding to increasing to decreasing number of clicks.

30. At least one computer readable storage medium as recited in claim 21, wherein the next clicked objects are advertisement links.
